(19) United States
(12) Patent Application Publication
(10) Pub. No.: US 2022/0114912 A1
(43) Pub. Date: Apr. 14, 2022

(54) DIGITAL PLATFORM FOR PROXY MENTOR / MENTEE COMMUNICATION

(71) Applicant: MySureStart, Inc., New York, NY (US)

(72) Inventor: Taniya Mishra, New York, NY (US)

(73) Assignee: MySureStart, Inc., New York, NY (US)

(21) Appl. No.: 17/500,022

(22) Filed: Oct. 13, 2021

Related U.S. Application Data
(60) Provisional application No. 63/090,733, filed on Oct. 13, 2020.

(51) Int. Cl. G09B 19/00; G06N 3/08; G06F 16/903

(52) U.S. Cl. CPC G09B 19/00; G06F 16/90335; G06N 3/08

(57) ABSTRACT

Disclosed techniques describe a digital platform for proxy mentor/mentee communication. A digital platform that facilitates communication between a mentee and a plurality of mentors is provided. The needs of the mentee are determined. The mentee needs are used to define the plurality of mentors for the mentee. A query is obtained from a mentee and communicated to one or more of the mentors. A response is received from one or more mentors. Machine learning is performed by the digital platform using the response from the one or more mentors and the query from the mentee. A further query is received from the mentee. The further query is based on the set of determined needs. A specific mentor is queried with the further query, based on the machine learning. Bespoke information about the mentee is provided, based on the machine learning by the digital platform.

### RELATED APPLICATIONS

This application claims the benefit of U.S. provisional patent application “Digital Platform for Proxy Mentor/Mentee Communication” Ser. No. 63/090,733, filed Oct. 13, 2020.

The foregoing application is hereby incorporated by reference in its entirety.

### FIELD OF ART

This application relates generally to machine learning digital platforms and more specifically to digital platform for proxy mentor/mentee communication.

### BACKGROUND

Organizations are well acquainted with the difficulty of finding suitable candidates to join the organization. The gulf between the number of open positions and the quantity of qualified candidates available to fill those positions is well known. The shortage of candidates is often attributable to a “hot” economy, a dearth of qualified candidates, or both. To address these challenges, organizations can engage with various placement companies to help find suitable employees. Typically, candidate résumés or skill sets are required to be matched with a static list of skills or experiences desired by a company. If a candidate's skills or experiences match the organization's list of desired skills or experiences, then a “match” can be established, and perhaps a next step toward hiring can occur. Various candidates have different skills, experiences, motivations, desires, goals, and the like, so even if a match occurs, it doesn't necessarily mean that the organization's desire for finding a qualified candidate and the candidate's desire for finding employment will yield a positive outcome for any of the parties involved.

Social media is often used as a basis for job matching between potential employers and potential employees. An employer can post an opening on a social media or another job-related web site, advertise in a newspaper or other print periodical, or even post a “help wanted” sign at their place of business or a local gathering spot, such as a supermarket bulletin board. However, social media can also be used as a method for a potential employer to disqualify a potential employee because of an actual or perceived careless social media post. This kind of monitoring can occur in many different settings, such as high school settings, college settings, employment settings, political settings, to name just a few settings.

Broader economic and political situations can also make it difficult for an organization to find a suitable candidate. For example, during a booming national or international economy, the demand for employee candidates might be so high that not enough candidates with a desired skill set or experience are available. However, during a national or international recession, organizations may have to drastically cut hiring and look for only the “perfect” candidate in terms of skills and experiences. Furthermore, during a national or worldwide pandemic, organizations may be unable to find qualified candidates who are willing to face potential pandemic risks and who are not part of a temporary, government assistance program. Finding suitable candidates to join an organization as a new employee can be a very difficult task indeed.

### SUMMARY

Students, new hires, interns, trainees, re-trainees, those returning to school or the workforce, among others, can directly benefit by working with a mentor. The mentor, who is typically a teacher, an experienced coworker, a supervisor, or a manager, can guide the mentee through the many challenges associated with a rigorous academic program, acclimating to a new position, learning complex technical skills such as machine operation, and so on. An effective mentor directly benefits the mentee by guiding, coaxing, encouraging, and sometimes pushing the mentee through a program. A successfully trained mentee can benefit an organization such as an enterprise by expanding the pool of candidates trained to accomplish highly technical and specific job requirements. One hears all too often that organizations are desperate for candidates for open positions, but are unable to identify and attract qualified individuals. As a result, many organizations establish “training” programs because the benefits of such have been long understood. While apprenticeships of the past were used to offload children who in exchange were taught a trade, modern training programs are used to enhance skills, train for specific positions, inculcate company culture, and so on.

Mentoring relationships can be established between mentors and mentees such that the relationships directly benefit organizations such as companies, and also benefit individuals such as mentors and mentees. Mentors include coworkers, teachers, and others who have experience and skills that can be shared with mentees. As mentors and mentees engage, their communication and relational skills expand. Mentors develop and expand leadership skills by assisting mentees as they reason through challenges and manage problem solving strategies. Mentees learn and gain time management, technical, and other skills through the mentor-mentee interaction. Companies benefit from the development and transferal of skills, which creates a pipeline of leaders. Outside of a company or organization context, individuals seek mentors for personal growth in areas such as relationships, financial management, health, and exercise. Regardless of the context of the mentor-mentee relationship, the pairing of a mentor with a mentee must be a good one in order for the relationship to be successful.

Individuals often experience great difficulty in finding mentors who are available to take on new mentees, who possess the requisite expertise, and who are also a good fit relationally. Even large organization can have a limited number of mentors available to take on new mentees, thus limiting the pool mentors who can form a good pairing with a mentee. While mentor expertise and mentee needs might provide a good match, the mentor and the mentee might not work well together due to conflicting personalities, working hours, or expectations. The mentor and the mentee might have different learning styles and may struggle to communicate. The failure to communicate effectively can be due to differences in demographics, cultures, etc. Other difficulties can arise. Such difficulties can include differences in expectations or commitment to the working relationship, or a mismatch between mentor experience and mentee need. Other difficulties can include a change in job assignment and location for the mentor or the mentee, or a change in job responsibilities, any of which could limit available interaction time. Further, the style of mentorship might cause tension for the mentee. The mentee might want more direction and interaction than the mentor is able to provide, or the mentor might overload the mentee with assignments. Another common problem is the “time shift” between when a mentor is available to help and when a mentee requires input. In disclosed techniques, a computer-implemented method for increasing the number of mentors available to one mentee, improving communication between them, and using a machine-learning proxy to augment the process, can mitigate pairing challenges and facilitate successful mentor/mentee relationships.

Disclosed techniques address a digital platform for proxy mentor/mentee communication. A computer-implemented method for digital platform communication is disclosed comprising: providing a digital platform that facilitates communication between a mentee and a plurality of mentors; determining a set of needs for the mentee; defining the plurality of mentors for the mentee based on the set of needs; obtaining a query from the mentee and communicating the query to one or more of the plurality of mentors; receiving a response from the one or more of the plurality of mentors; performing machine learning, by the digital platform, using the response from the one or more of the plurality of mentors and the query from the mentee; and providing bespoke information about the mentee, based on the machine learning, by the digital platform. Embodiments include selecting the plurality of mentors from a larger pool of possible mentors. The selecting can be performed by the digital platform. The selecting can be based on recommendations by the digital platform. The recommendations can be provided to the mentee with the mentee making an ultimate selection. Embodiments include inferring mentee needs based on platform interactions. Embodiments include inferring mentee needs based on mentee responses to questions presented on the digital platform. Embodiments include obtaining a further query from the mentee. Embodiments include updating the bespoke information, based on performing additional machine learning. Embodiments include providing rank information to a hiring manager, wherein the rank information is based on the machine learning and the additional machine learning.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1A is a flow diagram for a digital platform for proxy mentor/mentee communication.

FIG. 1B is a further flow diagram for a digital platform for proxy mentor/mentee communication.

FIG. 2 is a flow diagram for digital platform learning.

FIG. 3 is a block diagram of a digital platform communication.

FIG. 4 is a diagram of user-digital platform interfaces.

FIG. 5 is an example of a convolutional neural network.

FIG. 6 is a system for a digital platform for proxy mentor/mentee communication.

### DETAILED DESCRIPTION

Mentor relationships have become increasingly emphasized due to the benefits that come from experienced mentors sharing their advice and skills with inexperienced mentees. Both parties increase their communication skills. The mentor builds leadership skills, and the mentee learns to think through challenges and create strategies to overcome them. Both can advance their professional and personal lives as a result. Employers offer mentorship programs to build a pipeline of future managers and leaders for their companies. However, both companies and individuals can struggle to find mentors who have the experience and skills necessary to assist the mentee. And even if a mentor matches those qualities for a mentee, the mentoring relationship can still fail if the pairing is unsatisfactory.

Differences in personalities, expectations, and availability can cause the mentoring relationship to fail. A mentee can expect more time and direction than a mentor is willing or able to provide. A mentor can expect a greater investment in availability and effort than the mentee has available. Learning styles and communication styles might differ, which can frustrate both the mentor and the mentee. The mentor and mentee might have different times of availability due to their location, jobs, or other responsibilities. Mentors might not be available when mentees need them. The mentor's experience might not line up with the mentee's needs. Or the mentor might have weaknesses, a limited point of view, or a one-sided approach that he transfers to the mentee. A failed mentoring relationship can result in transferred weaknesses, damaged relationships, lost opportunities, and lost revenue, among other negative possibilities.

In disclosed techniques, a digital platform for proxy mentor/mentee communication is shown. A digital platform that facilitates communication between a mentee and a plurality of mentors is obtained. A set of needs for the mentee is determined. The set of needs includes required skills. In embodiments, the mentee determines a set of mastered skills and calculates a growth trajectory metric. In other embodiments, third party input determines the set of needs. In embodiments, the third party can be a company. In other embodiments, the third party can be a manager or a mentor. Based on the set of needs, a plurality of mentors is defined for the mentee. This ensures that multiple mentors are available to the mentee and that the experiences and skills of the mentors match the needs of the mentee. The plurality of mentors is selected from a larger pool of possible mentors. In embodiments, the selecting is performed by the digital platform. In other embodiments, the selecting is based on recommendations from the digital platform that are provided to the mentee, and the mentee makes the ultimate selection of mentors. The plurality of mentors provides a curated set of individuals to coach the mentee. Providing a plurality of mentors for the mentee enables the mentee to connect with a variety of experienced individuals. Multiple mentors can provide the mentee with unique opinions and perspectives to consider more potential issues and make better decisions. A cross section of mentors minimizes the transfer of weaknesses and increases the transfer of strengths. Multiple mentors can increase a mentee's network and opportunities. Multiple mentors can ensure that others are available if one particular mentor is not.

In disclosed techniques, a query from a mentee is obtained and communicated to one or more of a plurality of mentors. In embodiments, the query can include a question, a request for information, a need, and so on. A response from one or more of the plurality of mentors is received. Using the response from the one or more of the plurality of mentors, the digital platform performs machine learning. Machine learning by the digital platform comprises training a neural network. The digital platform comprises a neural network. The digital platform observes a portion of the interactions between the mentee and plurality of mentors and learns from them. A further query from the mentee is received. The further query is based on the set of needs for the mentee. In embodiments, the query could be a follow up to the previous query. In other embodiments, the query could be a new query. The further query is evaluated by the digital platform using natural language processing. In other embodiments, the further query is generated by the digital platform on behalf of the mentee. In embodiments, the digital platform anticipates the next query of the mentee. In other embodiments, the digital platform provides a query the mentee did not know to ask. Based on machine learning, a specific mentor is queried with the further query. The specific mentor is chosen based on machine learning.

In disclosed techniques, based on the machine learning by digital platform, a further response is provided to the mentee. In embodiments, one or more of the mentors can provide a response to the further query. In embodiments, a specific mentor who is selected based on machine learning can provide a further response. The digital platform can augment a response from the specific mentor to provide the further response to the mentee. The augmenting includes adjusting the timing, tone, or repetition of the message. The tone of the message includes words determined by machine learning to be appropriate to the mentee. In embodiments, the digital platform can change the message from the mentor. In other embodiments, the digital platform can add its own message to the response from the mentor. In this way, the digital platform can improve communication challenges between the mentee and mentor that can result from different learning styles, personalities, and more. The further response is generated by the digital platform as a proxy, based on machine learning. The further response is generated without input from any of the plurality of mentors. In embodiments, if mentors are unavailable when the mentee needs them, the digital platform can provide further responses. In embodiments, if the mentee needs human interaction, the digital platform can alert one or more of the plurality of mentors. In embodiments, the further response is provided using a personal digital assistant. In embodiments, the mentee and mentor are unaware that the communication includes input from the digital platform based on machine learning.

Disclosed techniques include a computer-implemented method for digital platform communication. A digital platform that facilitates communication between a mentee and a plurality of mentors is provided. A set of needs for the mentee is determined. Based on the set of needs, a plurality of mentors is defined. A query from the mentee is obtained and communicated to the one or more of the plurality of mentors. A response is received from the one or more of the plurality of mentors. The digital platform performs machine learning using the response from the one or more from the plurality of mentors. A further query from the mentee is received. A further response based on the machine learning by the digital platform is provided.

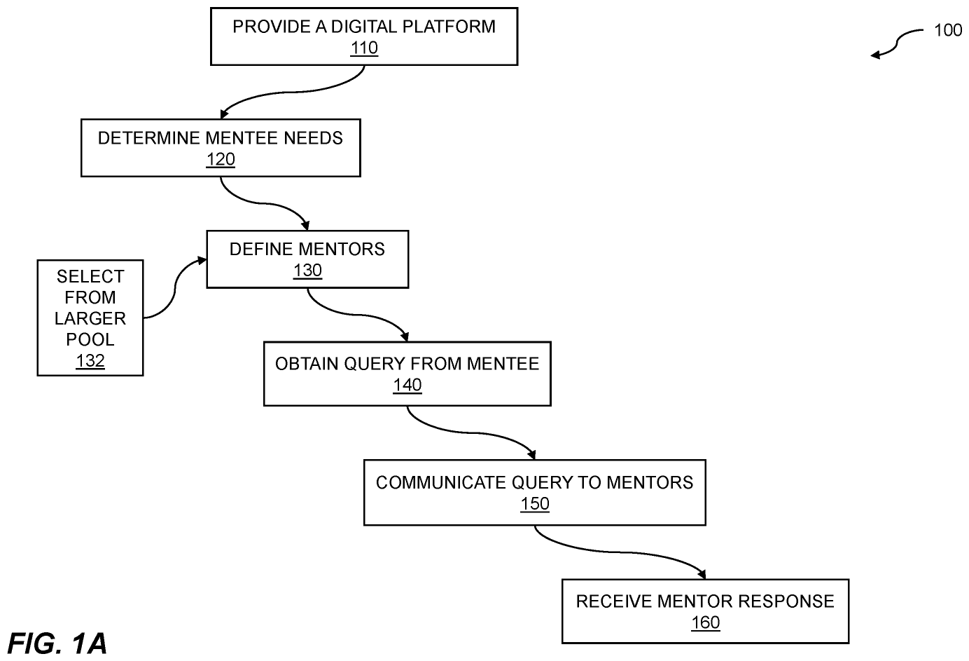

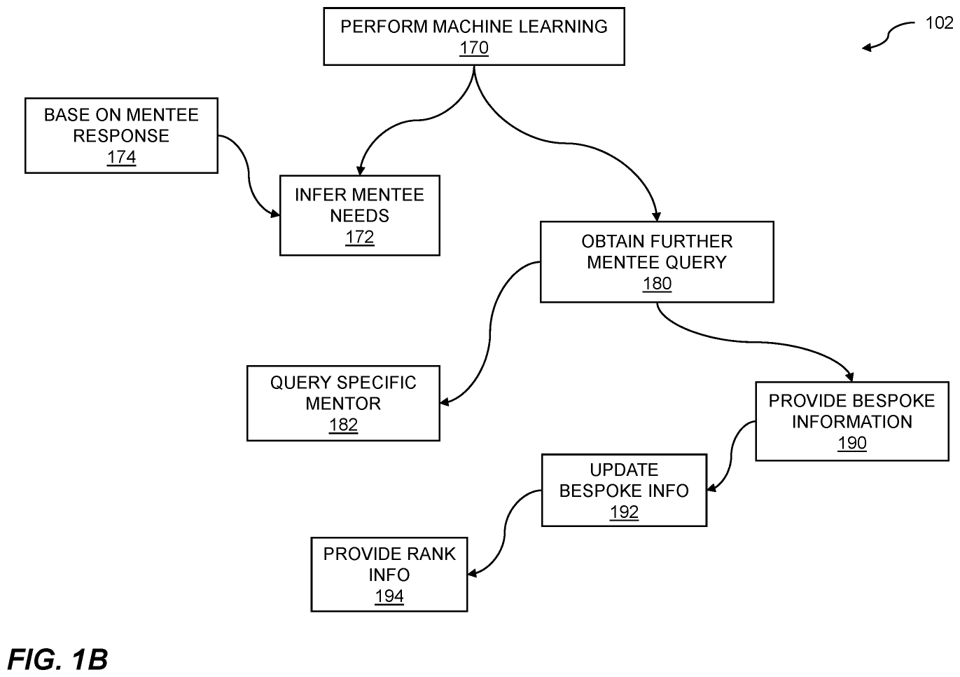

FIG. 1A is a flow diagram for a digital platform for proxy mentor/mentee communication. The flow diagram 100 shows a computer-implemented method for digital communication. The digital platform facilitates communication between a mentee and a plurality of mentors. A set of needs for the mentee is determined, and a plurality of mentors is defined based on the set of needs. A query from the mentee is obtained and communicated to the one or more mentors via the digital platform. A response is received from the one or more plurality of mentors. The digital platform performs machine learning using the response from the plurality of mentors and the query of the mentee. Bespoke information about the mentee is provided, based on the machine learning by the digital platform.

The flow 100 includes providing a digital platform 110 for proxy mentor/mentee communication. The digital platform facilitates communication between a mentee and a plurality of mentors. The communication can include interaction based on technical skills, organizational skills, personal skills, problem-solving skills, and more. Communication occurs via the digital platform using devices that include a laptop, a smartphone, a personal digital assistant, a tablet, or other communication device. Mentees can include students, interns, new hires, young professionals, and so on. Mentors can include team leaders, technical leads, managers, specialists, advisors, and the like. In embodiments, the digital platform has access to a plurality of mentors. In embodiments, the plurality of mentors includes employees of one company. In other embodiments the plurality of mentors includes employees of more than one company. In other embodiments the plurality of mentors includes independent contractors and other industry professionals. The digital platform is a neural network. The neural network observes communication between the mentee and the mentor and learns what questions to ask and how to ask them, as well as what answers to give and how to give them.

The flow 100 includes determining mentee needs 120. The mentee needs can include various requirements such as course and training requirements, certification and licensing requirements, and so on. In embodiments, the needs can include required skills. The mentee determines a set of skills already mastered. The digital platform can calculate a growth trajectory metric. The growth trajectory metric can include weekly and monthly goals. In embodiments, the digital platform assesses the difference between the skills the mentee has and the skills the mentee needs. This difference defines the growth trajectory metric in order to satisfy the set of needs of the mentee. In other embodiments, the mentee determines the set of needs. In still other embodiments, the set of needs is determined based on third party input, wherein the third party includes a company, a business, an enterprise, or the like. The company can list required skills needed for placement on a full-time position, and that list can be used to determine the mentee set of needs.

The flow 100 includes defining the plurality of mentors 130 for the mentee based on the set of needs. The plurality of mentors can comprise one or more of managers, supervisors, team leaders, professors, teachers, instructors, advisors, counselors, and so on. The mentors within the plurality of mentors can be appointed by a manager, boss, department head or chair, etc. The mentors can include volunteers such as other workers and employees. In the flow 100, the plurality of mentors can be selected from a larger pool 132 of mentors based on the mentee needs. This ensures a good skills/experience fit between the plurality of mentors and the mentee. In embodiments, the selecting of the plurality of mentors is performed by the digital platform based on the mentee needs and machine learning. In other embodiments, the selecting of the plurality of mentors is based on recommendations by the digital platform, which are provided to the mentee who makes the ultimate selection. The mentee can select a plurality of mentors based on experience, location, availability, coaching style, and so on. The selection process can mitigate against poor pairings. The plurality of mentors enables the mentee to connect with a variety of experienced individuals. The plurality of mentors offers unique opinions and perspectives to consider more issues, which enables the mentee to make better decisions. A plurality of mentors minimizes transfer of weaknesses and maximizes the transfer of strengths. A plurality of mentors increases a mentee's network and opportunities. A plurality of mentors can increase the likelihood that others are available if one particular mentor is not. The plurality of mentors can provide a curated set of individuals to coach the mentee.

The flow 100 includes obtaining a query 140 from the mentee. In embodiments, the query can include a question, a request for information, a need, and so on. A level of priority can be associated with the query. The query can be communicated via a laptop, a phone, a tablet, a mobile device, or some other communication device to the digital platform. The query can be obtained from the mentee using a variety of techniques such as text, an audio clip, a menu selection, and so on. The digital platform learns from the query by using machine learning. The flow 100 includes communicating the query 150 to one or more of a plurality of mentors. Various techniques can be used for communicating the query to the plurality of mentors such as electronic mail, a text message, an alert, a telephone call, and the like. In embodiments, the query is communicated to a plurality of mentors. The plurality of mentors to whom the query is communicated can include mentors with similar qualifications, experience, and talents. The communicating the query to the mentors can accomplish a redundancy or backup technique in the event that one or more of the mentors are unavailable at a time of a query. In other embodiments, the query is communicated to one particular mentor. The particular mentor can include a mentor with specific or unique talents, qualifications, etc.

The flow 100 further includes receiving a response from one or more of the plurality of mentors 160. A response from one or more of the plurality of mentors is received by the digital platform. In embodiments, the response can include technical advice, organizational advice, personal advice, career advice, course recommendations, and such. In other embodiments, the response can include a series of questions to consider. The questions can be used to obtain additional information from a mentee so that a mentor can better form a response to the request. The additional questions can include “thought provoking” questions that can help the mentee focus her or his query, career objectives, etc. In other embodiments, the response can include encouragement, warning, motivation, and so on. The response can be communicated to the digital platform using a laptop, phone, tablet, or other communication device.

FIG. 1B is a further flow diagram for a digital platform for proxy mentor/mentee communication. In the further flow 102, after receiving the mentor response 160, the digital platform performs machine learning 170 using the response from the one or more plurality of mentors and the query from the mentee. The digital platform performs machine learning to learn from the one or more responses from the mentors and communicates the response to the mentee. In embodiments, the digital platform learns which responses and which communications techniques are most effective for bringing about a desired result for the mentee. In embodiments, the communicating can include adjusting timing, tone, or repetition of a message. In a usage example, a first mentee responds best when presented with frequent, direct messages that clearly outline required steps. By contrast, a second mentee responds best when presented with occasional, gentle nudges by way of the messages. Machine learning by the digital platform comprises training a neural network. The digital platform comprises a neural network. The digital platform observes a portion of the interactions between the mentee and plurality of mentors and learns from them. The flow 100 further includes inferring mentee needs 172 based on platform interactions. A mentee interacting with the digital platform can provide specific, detailed queries, indicating that the mentee has clear objectives in mind and requires a mentor with specific expertise. Another mentee interacting with the digital platform can provide broad, general queries. The latter queries can indicate that the mentee requires assistance with focusing on objectives and asking appropriate questions. The flow 100 further includes inferring mentee needs based on mentee responses 174 to questions presented on the digital platform. Based on the inferred mentee needs, the digital platform can select additional questions, provide a course action, contact one or more appropriate mentors, etc.

In the flow 100, a further query from the mentee can be received 180. In embodiments, the further query is based on the set of needs for the mentee. In embodiments, the further query can be a follow up to the previous query. In other embodiments, the query can be a new query. In embodiments, the query can include a question, a request for information, a need, and so on. The further query is evaluated by the digital platform using natural language processing. The digital platform performs machine learning and learns from the query. In embodiments, the machine learning can include content, tone, timing, repetition, and such. In other embodiments, the further query is generated by the digital platform on behalf of the mentee. In embodiments, the digital platform anticipates the next query of the mentee. In some embodiments, the digital platform provides a query the mentee did not know to ask. The digital platform communicates the further query to one or more of the plurality of mentors. In embodiments, based on machine learning, a specific mentor is queried with the further query. The specific mentor is chosen based on the machine learning. The flow 100 further includes querying a specific mentor 182, based on the machine learning, with the further query. The specific mentor can be a preferred match, where the preferred match can be based on rank, skillset, experience, and so on.

The flow 100 includes providing bespoke information 190 about the mentee, based on the machine learning by the digital platform. The bespoke or tailored information can include mentee needs, mastered skills, eligibility, availability, and so on. Bespoke information about the mentee is information that is custom made, or tailored, uniquely for the mentee. In embodiments, the bespoke information about the mentee can include candidate attributes such as work ethic, attitude, ability to work with others, potential leadership capabilities, etc. The bespoke information can be unique information based on the machine learning, not merely a selection of preexisting, curated information. The bespoke information can change based on further machine learning. The flow 100 further includes augmenting a response from the specific mentor, by the digital platform, to update 192 the bespoke information. The augmenting can include adjusting the timing, tone, or repetition of a message. The tone of the message can include words determined by the machine learning to be appropriate to the mentee. The appropriate words can be associated with gender or gender identity, level of experience (e.g., pre-degree or pre-certification versus post), geographic location, and other demographic information. In other embodiments, the bespoke information or a further response is generated by the digital platform as a proxy, based on machine learning. The further response is generated without further input being obtained from any of the plurality of mentors. The further response is provided using a personal digital assistant. In embodiments, the further response is evaluated by the digital platform using natural language processing. The flow 100 further includes providing rank information 194 to a hiring manager, wherein the rank information is based on the machine learning and the additional machine learning. The rank information can be based on a grade point average, a number of certifications or licenses achieved, recommendations from current or previous employers or advisors, and the like. In embodiments, the rank information can include mentee growth potential. The mentee growth potential can include career, leadership, professional, personal, and other growth. In other embodiments, the rank information can include mentee engagement level. The engagement level can include an assessment of eagerness to learn, to take on new responsibilities, etc. The mentee engagement level can be inferred from mentee platform interactions. For example, frequent and/or diligent platform usage can be used to infer a higher level of engagement than infrequent and/or sporadic platform usage.

Various embodiments of the flow 100 and the flow 102 can be included in a computer program product embodied in a non-transitory computer readable medium that includes code executable by one or more processors. Various embodiments of the flow 100 and the flow 102, or portions thereof, can be included on a semiconductor chip and implemented in special purpose logic, programmable logic, and so on. Various embodiments of the flow 100 and the flow 102, or portions thereof, can be used for a processor-implemented method for digital platform communication.

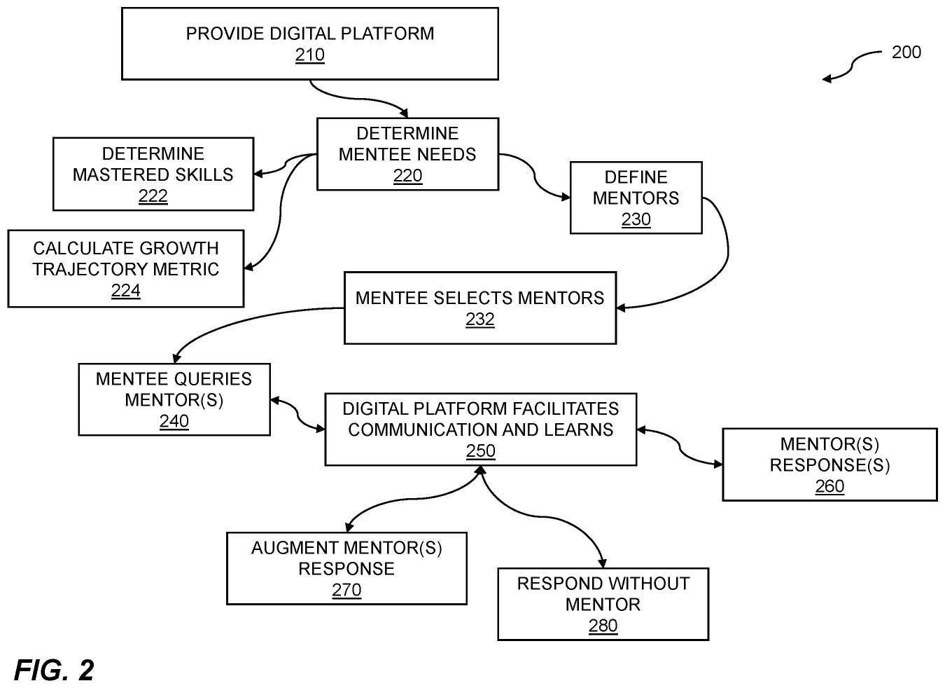

FIG. 2 is a flow diagram for digital platform learning. A computer-implemented method for digital platform communication includes providing the digital platform that facilitates communication between a mentee and a plurality of mentors. A set of needs for the mentee is determined. Based on the set of needs, a plurality of mentors for the mentee is defined. A query from the mentee is obtained and communicated to the one or more of a plurality of mentors. A response is received from the one or more of the plurality of mentors. The digital platform performs machine learning using the response from the one or more of the plurality of mentors, and the query from the mentee. Bespoke information about the mentee is provided, based on the machine learning by the digital platform.

The flow 200 includes providing a digital platform 210 that facilitates communication between a mentee and a plurality of mentors. The mentee can include a student, an intern, a new hire, and so on. The plurality of mentors can include a manager, a technical lead, a team leader, a specialist, a counselor, and more. The communication can include discussion of technical skills, organizational skills, personal skills, problem-solving skills, and more. Communication occurs through the digital platform using devices that include a laptop, a smartphone, a tablet, a personal digital assistant, a mobile device, or other communication device. In embodiments, the digital platform comprises a neural network. The neural network associated with the digital platform can accomplish machine learning.

The flow 200 includes determining a set of needs for the mentee 220. The needs include required skills, courses, certifications, and so on. In the flow 200, the mentee determines a set of skills already mastered 222. The skills already mastered can be determined based on courses taken, certificates received, work experience, etc. The skills can include technical skills such as operating specialized equipment, coding skills, analytical skills, and the like. In the flow 200, the digital platform can calculate a growth trajectory metric 224. The growth trajectory metric can include a value, a percentage, an assigned evaluation such as a grade, etc. The growth trajectory metric can be used to determine whether the mentee is progressing or growing at a required or expected rate, needs additional training, can be placed on an advanced trajectory, and so on. In embodiments, the growth trajectory metric can include weekly and monthly goals. In other embodiments, the growth trajectory can be for a year or greater. In embodiments, the digital platform uses machine learning and determines the set of needs of the mentee. In other embodiments, the set of needs is determined based on third-party input, wherein the third party includes a company, a business, an enterprise, a university, a research facility, or the like. In embodiments, the company can list required skills needed for placement in a full-time position, and that list can determine the mentee's set of needs.

The flow 200 includes defining a plurality of mentors for the mentee based on the set of needs 230. The plurality of mentors is selected from a larger pool of possible mentors, based on mentee needs. This selection ensures a good skills and experience fit between the mentee and the plurality of mentors. In embodiments, the selecting is performed by the digital platform based on mentee needs and machine learning. In other embodiments, the selecting is determined from recommendations based on machine learning by the digital platform. The machine-learned recommendations are provided to the mentor who makes the ultimate selection. A plurality of mentors enables a higher probably of a good pairing. A plurality of mentors enables a higher probability that at least one of the more than one of the plurality of mentors will be available. Having a plurality of mentors minimizes the conveying of weaknesses and maximizes the transferring of strengths to the mentee. A plurality of mentors increases the mentee's network and opportunities. The plurality of mentors provides a curated set of individuals to coach the mentee. The flow 200 includes the mentee selecting mentors 232 based on the recommendation of the digital platform. The digital platform recommends a plurality of mentors based on the needs of the mentee. In embodiments, the mentee selects the plurality of mentors based on various criteria including specific skills, location, coaching style, and so on.

The flow 200 includes obtaining a query from the mentee 240 and communicating the query to the one or more of the plurality of mentors. In embodiments, the query can include a question, a request for information, a need, and so on. The query can be communicated via a laptop, a phone, a tablet, a mobile device, or another communication device to the digital platform. The flow 200 includes facilitating communication between a mentee and a plurality of mentors and performing machine learning 250. The machine learning by the digital platform comprises training a neural network. The digital platform comprises a neural network. In embodiments, the query is communicated to a plurality of mentors. In other embodiments, the query is communicated to one particular mentor. The digital platform transfers a query and further queries, and a response and further responses, between the mentee and one or more of the plurality of mentors. The digital platform performs machine learning using queries from the mentee and using responses from the one or more of the plurality of mentors. The digital platform evaluates the queries and responses using natural language processing. The digital platform learns timing, tone, repetition, wording, and so on. A further query can be based on the set of needs of the mentee. Using machine learning, the digital platform queries a specific mentor with a further query. The specific mentor is chosen based on the machine learning. The further query is generated by the digital platform on behalf of the mentee. In embodiments, the digital platform anticipates the further query of the mentee. In other embodiments, the digital platform performs a query the mentee did not know to ask.

The flow 200 includes receiving a response from the one or more of the plurality of mentors 260. A response from one or more of the plurality of mentors is received by the digital platform. The digital platform performs machine learning using the response and communicates the response to the mentee. In embodiments, the response can include technical advice, organizational advice, personal advice, and such. In other embodiments, the response can include a series of questions to consider. In other embodiments, the response can include encouragement, warning, motivation, and so on. The response can be communicated to the digital platform using a laptop, a phone, a tablet, a personal digital assistant, a mobile device, or some other communication device.

The flow 200 includes the digital platform augmenting a response from the mentor 270 to provide the further response. The augmenting includes adjusting timing, tone, or repetition of a message. The tone of the message includes words determined by the machine learning to be appropriate to the mentee. In this way, the digital platform can adjust the query and response to improve communication between the mentor and mentee. This can mitigate against tension arising from different personalities and learning styles. The flow 200 includes generating a response by the digital platform as a proxy, based on the machine learning. The further response is provided without input being obtained from any of the plurality of mentors 280. The response is provided using a personal digital assistant. In embodiments, the digital platform is a proxy of a band of mentors or advisors, and it is implemented as a curated, adaptable learning system that has been personalized to a particular mentee based on the interactions with a particular plurality of mentors. In this way, if none of the plurality of mentors is available to the mentee, the digital platform is available to respond to mentee queries. In embodiments, if the digital platform determines that human interaction is needed, it can alert one or more of the plurality of mentors. This alerting can mitigate against availability issues between mentors and mentees. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on. Various embodiments of flow 200, or portions thereof, can be used for a processor-implemented method for machine learning.

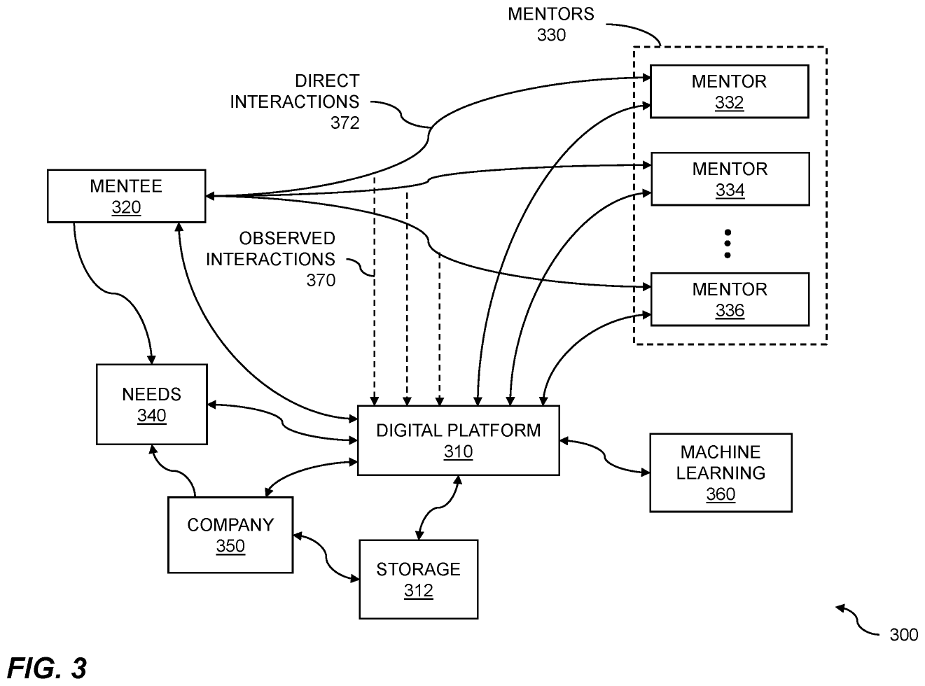

FIG. 3 is a block diagram of digital platform communication. A computer-implemented method for digital platform communication provides a digital platform that facilitates communication between a mentee and a plurality of mentors. A set of needs for the mentee is determined. The plurality of mentors for the mentee is defined based on the set of needs. A query is obtained from the mentee and is communicated to one or more of the plurality of mentors. A response is received from the one or more of the plurality of mentors. The digital platform performs machine learning using the response from the one or more of the plurality of mentors, and the query from the mentee. Bespoke information is provided about the mentee, based on the machine learning by the digital platform.

The block diagram 300 includes a digital platform 310 that facilitates communication between a mentee 320 and a plurality of mentors 330. The digital platform can be coupled to storage 312. The storage can include local memory, cache memory, storage associated with a server, cloud-based storage, and so on. The plurality of mentors can include mentors 332, 334, 336, and so on. While three mentors are shown, other numbers of mentors can be included within the plurality of mentors. The mentors within the plurality of mentors can represent different mentoring “skill sets”, such as academic advising, career advising, professional development, life coaching, and the like. A set of needs 340 is determined for the mentee. The needs can include course requirements, training or certification requirements, etc. In embodiments, the set of needs includes required skills. The set of needs can be used to gauge mentee progress, rank, qualification, and the like. In embodiments, the set of needs can be used to determine a set of skills mastered by the mentee. The mastered skills can be associated with mentee growth academically, professionally, etc. Further embodiments include calculating a mentee growth trajectory metric. The set of needs does not need to be limited only to the needs of the mentee. In embodiments, the set of needs is determined based on input from a third party. The third party can include a company 350, business, an enterprise, etc. In a usage example, a company can be searching for candidates for employment so can create a set of needs based on requirements of a particular position.

A plurality of mentors for the mentee is defined based on the set of needs 340. The plurality of mentors is selected from a larger pool of possible mentors. In embodiments, the set of skills mastered by the mentee is evaluated by the plurality of mentors. The plurality of mentors can assign a grade, a rank, an approval, etc. In other embodiments, the set of skills mastered by the mentee is evaluated by the digital platform. A digital platform can calculate a mentee growth trajectory metric. The skills mastery and the mentee growth trajectory can be stored in storage 312. Access to the information provided by the mentee can be controlled by the company.

A query is obtained from the mentee and communicated to one or more of the plurality of mentors. A response is received from the one or more plurality of mentors. The digital platform performs machine learning 360 using the response from the one or more plurality of mentors. The digital platform observes 370 the direct interaction 372 between the mentee and the plurality of mentors. The machine learning by the digital platform comprises training a neural network. The digital platform comprises a neural network. In embodiments, a further query is received from the mentee. The further query can be based on the set of needs for the mentee. In embodiments, based on machine learning, the further query can be generated by the digital platform on behalf of the mentee. Further based on the machine learning, a specific mentor can be queried with the further query. The mentor is chosen based on the machine learning. In embodiments, a further response from the specific mentor is augmented by the digital platform to provide the further response. The augmenting includes adjusting timing, tone, or repetition of the message. The timing can include frequent reminders or messages, occasional messages, and so on. The tone of the messages can range from stern to gentle. The tone of the message includes words determined by the machine learning to be appropriate to the mentee. In this way, the digital platform improves communication between the mentee and mentor, which can mitigate against tensions and a poor pairing. In embodiments, the further response is generated by the digital platform as a proxy, based on machine learning. The further response is generated without further input being obtained from any of the plurality of mentors. In this way, the digital platform can provide a response when none of the plurality of advisors is available, which mitigates against frustrations due to availability issues. The further response is provided using a personal digital assistant. The further query is evaluated by the digital platform using natural language processing.

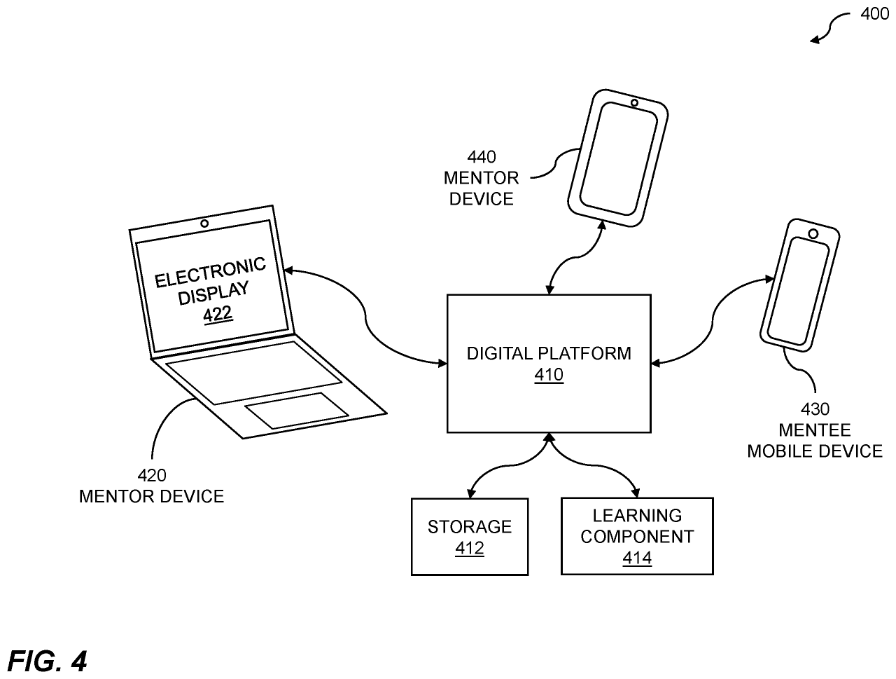

FIG. 4 is a diagram of user-digital platform interfaces. A computer-implemented method for digital platform communication 400 provides a digital platform that facilitates communication between a mentee and a plurality of mentors. The mentee can include a student, an intern, a trainee, a temporary employee, and so on. The plurality of mentors can include one or more of professors, teachers, advisors, job coaches, employers, and the like. The mentee can further include a candidate for a position such as a professional position, while a mentor can include a potential employer. The mentee and the mentors can interface with the digital platform 410. The digital platform can comprise one or more of computers, processors, servers, processor cores within integrated circuits or chips, and so on. The digital platform can be coupled to storage 412. The storage can include local, cache, remote, cloud, and other storage. The digital platform can use the storage to store queries from mentees, responses from mentors, intermediate results, data, historical data, etc. The digital platform can be further coupled to a learning component 414. The learning component can accomplish machine learning, where the machine learning by the digital platform can include training a network such as a neural network. The training the neural network can be based on techniques such as supervised training, unsupervised or adaptive learning, and the like. The machine learning can include deep learning techniques, and so on.

The interfacing with the digital platform can be accomplished using a variety of communication devices that can include laptops, smartphones, tablets, personal digital assistants, mobile devices, and more. In embodiments, a mentor uses devices that include a laptop 420 with an electronic display 422 and a tablet 440. In embodiments, a mentee uses communication devices that include a phone 430. The mentee and the plurality of mentors use these devices to communicate with each other via the digital platform, while the digital platform observes the interactions. The communication between the devices can include wired techniques, wireless techniques, a combination of wired and wireless techniques, and so on. The communication includes queries from the mentee and responses from the plurality of mentors. In embodiments, the query can include a question, a request for information, a need, and so on. In embodiments, the response can include technical advice, organizational advice, personal advice, and such.

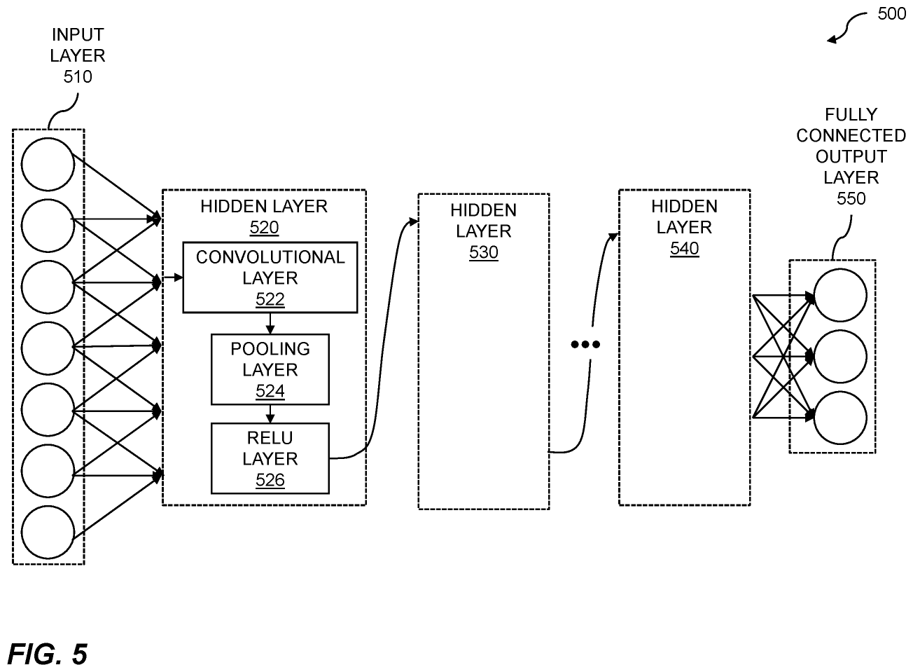

FIG. 5 is an example of a convolutional neural network. The convolutional neural network 500 can be used for digital platform communication. Convolutional neural networks imitate neurons in the neocortex of the human brain. This resemblance enables software to “learn” to recognize and identify patterns in data, where the data can include queries from mentees and responses from mentors. The simulated neocortex, or artificial neural network, uses mathematical formulas that are evaluated on processors.

A convolutional neural network can be based on layers including an input layer 510, a fully connected output layer 550, hidden layers 520, 530, 540, and so on. The input layer 510 can receive input data, where the input data can be collected into groups, which can be performed in localities. The input layer can perform processing such as partitioning collected data into non-overlapping partitions. The neural network can include a plurality of hidden layers. The hidden layers include convolutional layers 522, pooling layers 524, rectified linear unit (ReLU) layers 526, and so on. The convolutional layers 522 perform convolutional operations. The convolutional layers can reduce the amount of data feeding into a fully connected layer. The pooling layers 524 perform pooling operations. The ReLU layers 526 can perform rectification operations. Outputs of one layer are fed to next layer. Weights adjust the output of one layer as it is fed to the next layer until it reaches the final output layer 550. The convolutional neural network can be trained to identify timing, tone, repetition of a message, and so on, between a mentee and a mentor.

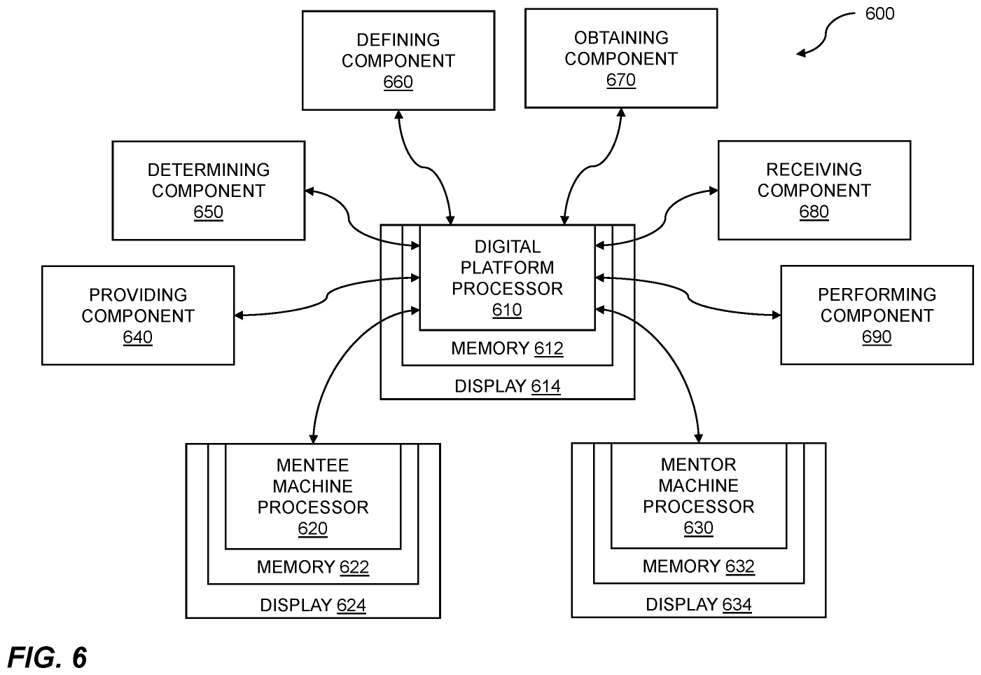

FIG. 6 is a system for a digital platform for proxy mentor/mentee communication. The system 600 can include one or more digital platform processors 610 coupled to a memory 612 which stores instructions. The system 600 can include a display 614 coupled to the one or more processors 610 for displaying data, intermediate steps, instructions, and so on. In embodiments, one or more processors 610 are attached to the memory 612 where the one or more processors, when executing the instructions which are stored, are configured to: provide a digital platform that facilitates communication between a mentee and a plurality of mentors; determine a set of needs for the mentee; define the plurality of mentors for the mentee based on the set of needs; obtain a query from the mentee and communicating the query to one or more of the plurality of mentors; receive a response from the one or more of the plurality of mentors; perform machine learning, by the digital platform, using the response from the one or more of the plurality of mentors and the query from the mentee; and provide bespoke information about the mentee, based on the machine learning by the digital platform.

The system 600 can include one or more mentee machines. The example mentee machine shown comprises one or more mentee machine processors 620 coupled to a memory 622 which can store and retrieve instructions, and a display 624. The memory 622 can be used for storing instructions, needs data, mastered skills data, query data, response data, etc. The display 624 can be any electronic display, including but not limited to a computer display, a laptop screen, a tablet computer screen, a smartphone display, a mobile device display, or the like.

The system 600 can include one or more mentor machines. The example mentor machine shown comprises one or more mentor machine processors 630 coupled to a memory 632 which can store and retrieve instructions, and a display 634. The memory 632 can be used for storing instructions, query data, response data, evaluation data, etc. The display 634 can be any electronic display, including but not limited to a computer display, a laptop screen, a tablet computer screen, a smartphone display, a mobile device display, or the like.

The system 600 can include a providing component 640. The providing component 640 can include functions and instructions for providing a digital platform that facilitates communication between a mentee and a plurality of mentors. The providing component can also provide a further response to the mentee based on the machine learning by the digital platform. The mentee can be a student, an intern, a new hire, and so on. The plurality of mentors can be managers, team leads, technical leads, specialists, and so on. In embodiments, the digital platform uses machine learning and augments the response from the specific mentor to provide the further response to the mentee. The augmenting can include adjusting the timing, tone, or repetition of a message. The tone of the message can include words determined by the machine learning to be appropriate to the mentee. In other embodiments, the further response is generated by the digital platform as a proxy, based on machine learning. The further response is generated without further input being obtained from any of the plurality of mentors. The further response is provided using a personal digital assistant. In embodiments, the further response is evaluated by the digital platform using natural language processing.

The system 600 can include a determining component 650. The determining component can include functions and instructions for determining a set of needs for the mentee. The set of needs includes required skills. A set of skills mastered by the mentee is determined. A mentee growth trajectory metric is calculated. In embodiments, the set of needs is determined based on third-party input, where the third party includes a company, a business, an enterprise, or the like.

The system 600 can include a defining component 660. The defining component can include functions and instructions for defining the plurality of mentors for the mentee based on the set of needs. The plurality of mentors is selected from a larger pool of possible mentors. In embodiments, the selecting is performed by the digital platform. In other embodiments, the selecting is based on recommendations by the digital platform, which are provided to the mentee, who makes the ultimate selection. The plurality of mentors provides a curated set of individuals to coach the mentee.

The system 600 can include an obtaining component 670. The obtaining component can include functions and instructions for obtaining a query from the mentee and communicating the query to one or more of the plurality of mentors. In embodiments, the query can include a question, a request for information, a need, and so on. In embodiments, the query is communicated to a plurality of mentors. In other embodiments, the query is communicated to one particular mentor.

The system 600 can include a receiving component 680. The receiving component can include functions and instructions for receiving a response from the one or more of the plurality of mentors and receiving a further inquiry from the mentee. In embodiments, the response can include technical advice, organizational advice, personal advice, and such. In other embodiments, the response can include a series of questions to consider. In other embodiments, the response can include encouragement, concerns, motivation, and so on. The further query from the mentee is based on the set of needs for the mentee. In embodiments, the further query can be a follow up to the previous query. In other embodiments, the query can be a new query. In embodiments, the query can include a question, a request for information, a need, and so on. In other embodiments, the further query is generated by the digital platform on behalf of the mentee. In embodiments, the digital platform anticipates the next query of the mentee. In some embodiments, the digital platform provides a query the mentee did not know to ask. The digital platform communicates the further query to one or more of the plurality of mentors. In embodiments, based on machine learning, a specific mentor is queried with the further query. The specific mentor is chosen based on the machine learning.

The system 600 can include a performing component 690. The performing component can include functions and instructions for the digital platform for performing machine learning using the response from the one or more of the plurality of mentors. In embodiments, the digital platform learns content, tone, timing, repetition, and such. Machine learning by the digital platform comprises training a neural network. The digital platform comprises a neural network. The digital platform observes a portion of the interactions between the mentee and plurality of mentors and learns from them.

In embodiments, the system 600 comprises a computer system for digital platform communication comprising: a memory which stores instructions; one or more processors attached to the memory wherein the one or more processors, when executing the instructions which are stored, are configured to: provide a digital platform that facilitates communication between a mentee and a plurality of mentors; determine a set of needs for the mentee; define the plurality of mentors for the mentee based on the set of needs; obtain a query from the mentee and communicating the query to one or more of the plurality of mentors; receive a response from the one or more of the plurality of mentors; perform machine learning, by the digital platform, using the response from the one or more of the plurality of mentors; and provide a further response based on the machine learning by the digital platform to the mentee.

In embodiments, the system 600 can include a computer program product embodied in a non-transitory computer readable medium for digital platform communication, the computer program product comprising code which causes one or more processors to perform operations of: providing a digital platform that facilitates communication between a mentee and a plurality of mentors; determining a set of needs for the mentee; defining the plurality of mentors for the mentee based on the set of needs; obtaining a query from the mentee and communicating the query to one or more of the plurality of mentors; receiving a response from the one or more of the plurality of mentors; performing machine learning, by the digital platform, using the response from the one or more of the plurality of mentors; and providing a further response based on the machine learning by the digital platform to the mentee.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation, or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, and store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for digital platform communication comprising:
providing a digital platform that facilitates communication between a mentee and a plurality of mentors;
determining a set of needs for the mentee;
defining the plurality of mentors for the mentee based on the set of needs;
obtaining a query from the mentee and communicating the query to one or more of the plurality of mentors;
receiving a response from the one or more of the plurality of mentors;
performing machine learning, by the digital platform, using the response from the one or more of the plurality of mentors and the query from the mentee; and
providing bespoke information about the mentee, based on the machine learning, by the digital platform.

2. The method of claim 1 further comprising selecting the plurality of mentors from a larger pool of possible mentors.

3. The method of claim 2 wherein the selecting is performed by the digital platform.

4. The method of claim 2 wherein the selecting is based on recommendations by the digital platform.

5. The method of claim 4 wherein the recommendations are provided to the mentee with the mentee making an ultimate selection.

6. The method of claim 1 wherein the set of needs includes required skills.

7. The method of claim 6 further comprising determining a set of mastered skills by the mentee.

8. The method of claim 6 further comprising calculating a mentee growth trajectory metric.

9. The method of claim 6 wherein the set of needs is determined based on input from a third party.

10. (canceled)

11. The method of claim 1 wherein the digital platform observes a portion of interactions between the mentee and the plurality of mentors.

12. The method of claim 1 wherein the plurality of mentors provides a curated set of individuals to coach the mentee.

13-14. (canceled)

15. The method of claim 1 further comprising obtaining a further query from the mentee.

16. The method of claim 15 wherein the further query is based on the set of needs that was determined.

17. The method of claim 15 further comprising querying a specific mentor, based on the machine learning, with the further query.

18. The method of claim 17 further comprising augmenting a response from the specific mentor, by the digital platform, to update the bespoke information.

19. The method of claim 18 wherein the augmenting includes adjusting timing, tone, or repetition of a message.

20. The method of claim 19 wherein the tone of the message includes words determined by the machine learning to be appropriate to the mentee.

21-24. (canceled)

25. The method of claim 15 further comprising updating the bespoke information, based on performing additional machine learning.

26. The method of claim 25 further comprising providing rank information to a hiring manager, wherein the rank information is based on the machine learning and the additional machine learning.

27. The method of claim 26 wherein the rank information includes mentee growth potential.

28. The method of claim 26 wherein the rank information includes mentee engagement level.

29. The method of claim 28 wherein the mentee engagement level is inferred from mentee platform interactions.

30. The method of claim 1 further comprising inferring mentee needs based on platform interactions.

31-32. (canceled)

33. The method of claim 1 wherein the bespoke information comprises leadership training.

34. (canceled)

35. A computer program product embodied in a non-transitory computer readable medium for digital platform communication, the computer program product comprising code which causes one or more processors to perform operations of:
providing a digital platform that facilitates communication between a mentee and a plurality of mentors;
determining a set of needs for the mentee;
defining the plurality of mentors for the mentee based on the set of needs;
obtaining a query from the mentee and communicating the query to one or more of the plurality of mentors;
receiving a response from the one or more of the plurality of mentors;
performing machine learning, by the digital platform, using the response from the one or more of the plurality of mentors and the query from the mentee; and
providing bespoke information about the mentee, based on the machine learning, by the digital platform.

36. A computer system for digital platform communication comprising:
a memory which stores instructions;
one or more processors attached to the memory wherein the one or more processors, when executing the instructions which are stored, are configured to:
provide a digital platform that facilitates communication between a mentee and a plurality of mentors;
determine a set of needs for the mentee;
define the plurality of mentors for the mentee based on the set of needs;
obtain a query from the mentee and communicate the query to one or more of the plurality of mentors;
receive a response from the one or more of the plurality of mentors;
perform machine learning, by the digital platform, using the response from the one or more of the plurality of mentors and the query from the mentee; and
provide bespoke information about the mentee, based on the machine learning by the digital platform.
